(19) United States
(12) Patent Application Publication
(10) Pub. No.: US 2004/0219946 A1
(43) Pub. Date: Nov. 4, 2004

(54) Method and apparatus for extending the functionality of off-line wireless device storage for wireless multi-media devices

(76) Inventor: Fathy Yassa, Soquel, CA (US)

Correspondence Address: Fathy Yassa, 4439 Esta Lane, Soquel, CA, 95073, US

(21) Appl. No.: 10/776,628

(22) Filed: Feb. 9, 2004

Related U.S. Application Data
(60) Provisional application No. 60/446,434, filed on Feb. 12, 2003.

(51) Int. Cl. H04M 1/00

(52) U.S. Cl. 455/550.1; 455/556.1

(57) ABSTRACT

A method and apparatus for wireless delivery of content to a hand held device.

### CLAIM OF PRIORITY

This Application claims priority from USPTO provisional application No. 60/446,434 filed on Feb. 12, 2003 and incorporates said application by reference as if fully set forth herein. This application also incorporates by reference the applications entitled METHOD AND APPARATUS FOR A PROGRAMMABLE HAND HELD MULTI-MEDIA DEVICE and METHOD AND APPARATUS TO ADD FUNCTIONALITY TO GAMING DEVICES both filed contemporaneously with this instant application.

### BACKGROUND OF THE INVENTION

The invention disclosed here describes an exemplary method and apparatus for the storage of information for use on a mobile device and more specifically, mobile wireless devices.

Mobile wireless devices generally fall under the category of hand held devices, and include cell phones, personal digital assistants, etc. These devices share the common characteristic of being small, easily transported, and useable under most circumstances. Unlike portable computers and other larger mobile devices, hand-held devices do not require a surface to be placed on, nor do they usually have fixed or removable, mass storage devices such as hard drives, magneto-optical drives, or optical drives. The storage is generally limited to on-board memory or small removable memory such as flash media cards.

As a natural and direct consequence of the lack of a mass storage device, hand held devices are limited in the functionality that they provide. Specifically, they lack multi-media capabilities. For example, few hand held devices have CD quality audio playback capabilities. Fewer still have broadcast quality video playback. Both applications require the presence of a copious amounts of memory, usually only available on mass storage devices.

### Previous Solutions

The standard solution to the problem of excess cost, size, or weight, is to remove the offending component from the system. This was first seen in the dumb terminals of yesteryear. A dumb terminal is a type of terminal that consists of a keyboard and a display screen that can be used to enter and transmit data to, or display data from, a computer to which it is connected. A dumb terminal, in contrast to an intelligent terminal, has no independent processing capability or auxiliary storage and thus cannot function as a stand-alone device. Thus a dumb terminal could be manufactured at a fraction of the cost of an intelligent device. As main frame computer systems were replaced with servers and local networks, mostly because of the lowering costs and higher performance of personal computers, the dumb terminal solution became obsolete. The average personal computer was capable of acting as a stand alone device without the need to off-load its processing or storage to another, more powerful device.

However, the advent of miniaturization has caused the concept of the dumb terminal to be resurrected. Most notably, small devices usually have sufficient memory and processing power, they may not have adequate storage space as storage capacity may be space prohibitive. Thus the concept of a thin client was developed. A thin client is a low-cost, centrally-managed computer devoid of CD-ROM players, diskette drives, substantial hard drives, and expansion slots. The term derives from the fact that small computers in networks tend to be clients and not servers. Since the idea is to limit the capabilities of these computers to only essential applications, they tend to be purchased and remain “thin” in terms of the client applications they include.

Dumb terminals were notoriously slow as the main frame was responsible for all of the computing, including, such mundane task as screen drawing. Thin clients are a substantial improvement, but tend to be general purpose and limited to computer systems.

### BRIEF SUMMARY OF THE INVENTION

The invention relates to a method and apparatus for extending the functionality of hand held devices by adding wireless storage capacity to the device.

### BRIEF DESCRIPTION OF THE DRAWINGS

FIG. 1 illustrates a direct wireless connection between a hand held device and a mass storage unit.

FIG. 2 illustrates a wireless connection between a hand held device and a mass storage device via the public internet.

FIG. 3 illustrates a connection between a wireless hand held device and web enabled mass storage device.

FIG. 4 illustrates a wireless device downloading information on one wireless channel and sending to a mass storage device via another channel.

### DETAILED DESCRIPTION OF THE EMBODIMENTS

The invention herein disclosed provides the next generation of remote access via wireless-enabling mass storage devices that can transmit information to a hand held device without being physically a part of the wireless devices. Thus, while within communications range, the hand held device can provide substantially the same functionality as a device with a mass storage device attached, yet retain the mobility of a traditional hand held device. Today, some of the more popular wireless protocols include infra-red, fast infra-red, and 802.11.

The invention is further novel in that the off-line storage device need not be connected to a computer. The mass storage device described herein is any device capable of storing digital data. For purposes of this disclosure, a mass storage device may be fixed or removable, magnetic or optical, or any combination thereof. Included would be all forms of DVD, CD, PVR, VCR, DAT, and audiotape. Further the mass storage device could be a stand-alone dedicated system or it could be included in a general-purpose system such as a computer. What is important, is that the “brains” of the system primarily reside in the hand held device and not the storage device.

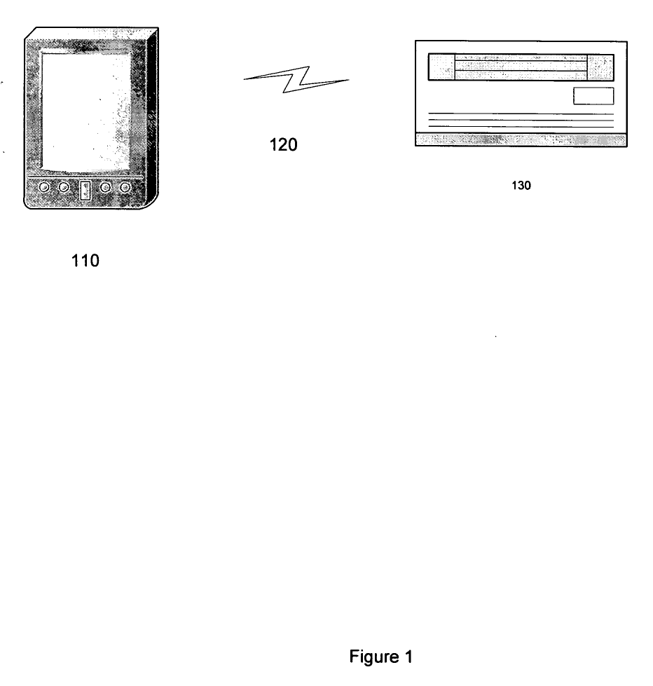

FIG. 1 illustrates one embodiment of the invention. Wireless hand held device 110 communicates bi-directionally via channel 120 with mass storage device 130. Mass storage device 130 is any device such as a hard drive, optical drive, etc, configured with wireless communications.

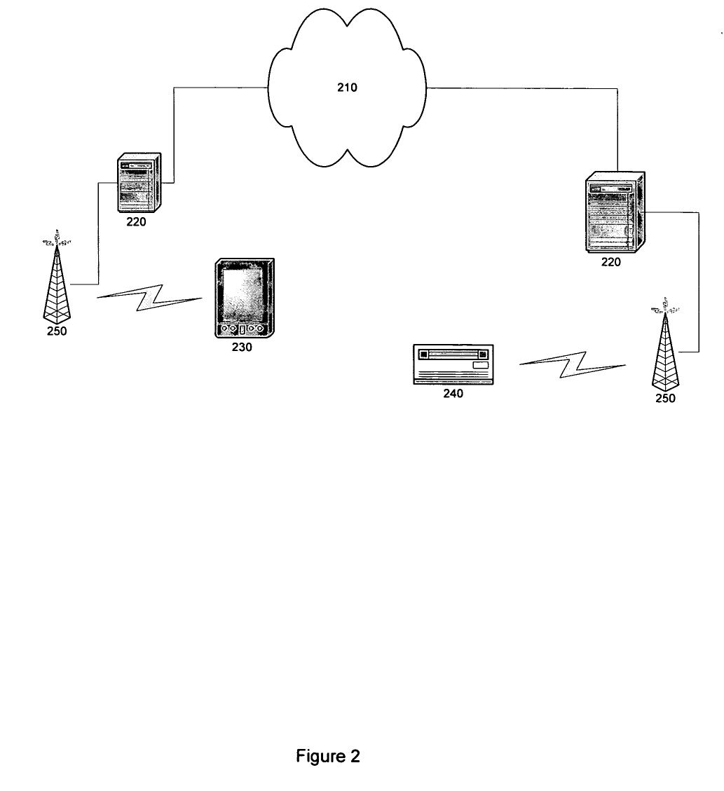

FIG. 2 illustrates yet another embodiment of the invention, the mass storage device 240 is wirelessly connected to a wide area network such as the public Internet 210 via access point 220 and wireless connector 250 and the hand held device is wirelessly connected through an access point. The hand held device 250 is also wirelessly connected to the internet 210 via access point 220 and wireless connector 250.

For purposes of this disclosure, a wide area global network is any network with addressable nodes such as the public internet or a private network.

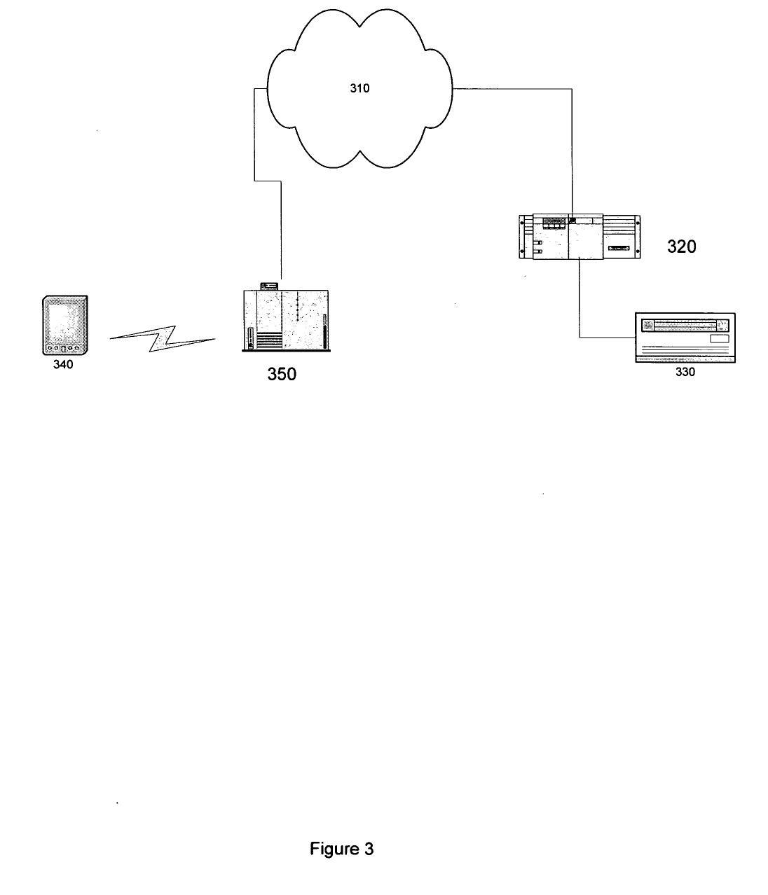

FIG. 3 illustrates a further embodiment of the invention, where the mass storage device 330, is connected to the internet 310, via access point 320. The hand held device 340 is wireless connected to the internet 310 via access point 350.

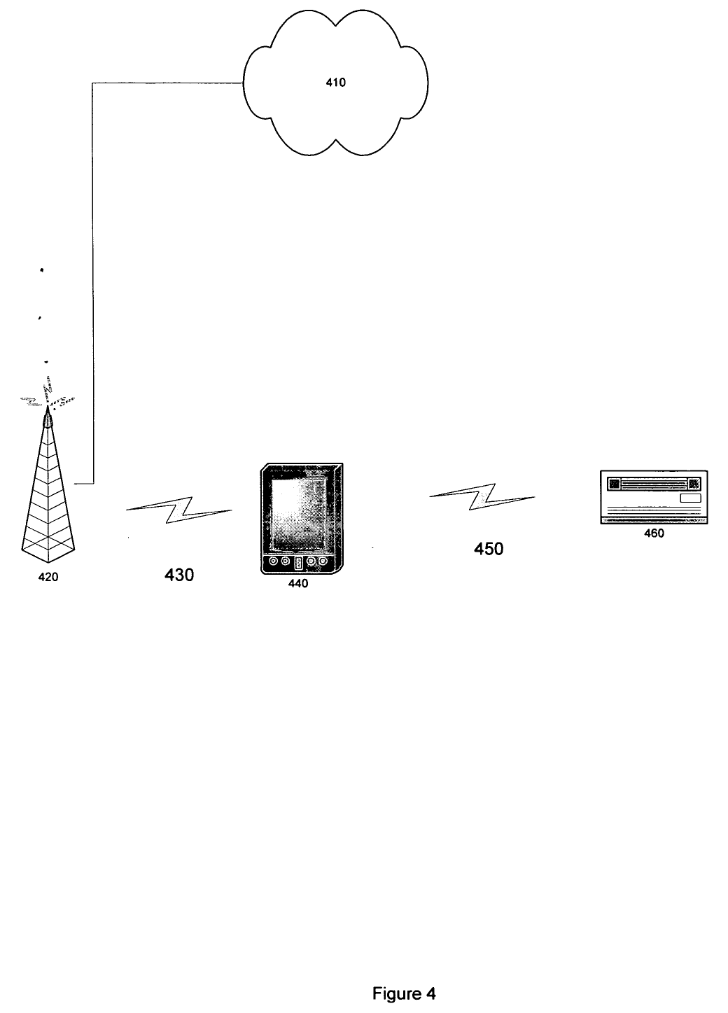

FIG. 4 illustrates yet another embodiment of the invention, were the hand held 440 is wireless connected to the internet 410 via wireless connector 420 over wireless channel 430. This permits downloading from the internet to the hand held device which then sends the information via wireless channel 450 to mass storage device 460.

In one embodiment of the invention, the information stored on the mass storage device is in the native hand held device format. As such the mass storage device essentially performs a dump of its contents.

In another embodiment of the invention, the information stored on the mass storage device is in the native language of the mass storage device. The device would then convert it to the hand held native language before transmitting.

In yet another embodiment, the information may be stored in one or more formats.

We claim:

1. A system for enhancing the functionality of a wireless hand held device through non-local storage comprising a first module configured as a hand held wireless device and a second module configured as a mass storage device, said first and second module configured with bi-directional communication; where said first module controls said second module.

2. The system of claim 1, where the hand held wireless device is further configured to connect directly to a wide area global network.

3. The system of claim 1, where the mass storage device has wireless connectivity.

4. The system of claim 1, where the mass storage device is connected directly to a wide area global network.

5. The system of claim 4, where the mass storage device is connected via a computer.

6. The system of claim 4, where the mass storage device is connected to the network without a computer.

7. The system of claim 1, where the hand held device downloads from the mass storage device.

8. The system of claim 1, where the hand held device streams from the mass storage device.

9. The system of claims 7 or 8, where the hand held device and the mass storage device transmit data via a wide area global network.

10. The system of claims 7 or 8, where the hand held device and the mass storage device directly transmit wirelessly.

11. The system of claims 7 or 8, where the information stored on the mass storage device is not in a format native to said hand held device, such that said hand held device translates said information

12. The system of claim 1, where the hand held downloads from the wide area global network.

13. The system of claim 11, where the mass storage device downloads from the hand held device.
